(19) United States
(12) Patent Application Publication
(10) Pub. No.: US 2014/0355787 A1
(43) Pub. Date: Dec. 4, 2014

(54) ACOUSTIC RECEIVER WITH INTERNAL SCREEN

(71) Applicant: Knowles Electronics, LLC, Itasca, IL (US)

(72) Inventors: Mekell Jiles, Flossmoor, IL (US); Erik Wiederholtz, Saint Charles, IL (US); Evan Llamas-Young, Algonquin, IL (US); Thomas E. Miller, Arlington Heights, IL (US)

(73) Assignee: Knowles Electronics, LLC, Itasca, IL (US)

(21) Appl. No.: 14/284,962

(22) Filed: May 22, 2014

Related U.S. Application Data
(60) Provisional application No. 61/829,576, filed on May 31, 2013.

(51) Int. Cl. H04R 3/04

(52) U.S. Cl. CPC H04R 3/04
USPC 381/98

(57) ABSTRACT

An acoustic apparatus includes a high frequency driver that has a first front volume and a low frequency driver that has a second front volume. The first front volume and the second front volume communicate with each other to form a common front volume. At least one acoustic resistance is placed between the first front volume and the second front volume. The acoustic resistance acts as a low pass filter.

### CROSS REFERENCE TO RELATED APPLICATIONS

This patent claims benefit under 35 U.S.C. §119 (e) to U.S. Provisional Application No. 61/829,576 entitled “Acoustic Receiver with Internal Screen” filed May 31, 2013, the content of which is incorporated herein by reference in its entirety.

### TECHNICAL FIELD

This application relates to acoustic devices and, more specifically, to LF drivers in these devices.

### BACKGROUND OF THE INVENTION

Various types of microphones and receivers have been used through the years. In these devices, different electrical components are housed together within a housing or assembly. For example, a receiver typically includes a coil, bobbin, stack, among other components and these components are housed within the receiver housing. Other types of acoustic devices may include other types of components.

Some receivers are configured with a high frequency (HF) driver and a separate low frequency (LF) driver. The HF driver produces high frequency sounds for a listener while a LF driver produces low frequency sounds. Typically, the HF driver and the LF driver transmit their respective sound energy to a user for listening via one or more sound tubes.

The sound quality of a speaker is typically desired to be free from distortions, resonances, or other negative effects. For instance, speakers are used in systems such as hearing aids, in music/entertainment devices, and computers (to mention a few examples) and these devices present sound to users. In all of these systems, the user desires and expects the highest in terms of sound quality and is typically disappointed if that sound quality is not achieved. Both low and high frequency drivers are often used in these devices.

Unfortunately, when both low frequency and high frequency drivers are used, each of the high frequency sounds and the low frequency sounds have resonant peaks and these peaks tend to add together as the sound exits the devices. The sum of the individual driver resonances can add in unpredictable and often unpleasant ways. Consequently, the overall sound quality of the system is degraded and the user hears this degraded sound quality. Previous attempted solutions were generally large in size, making them unsuitable for many applications.

### BRIEF DESCRIPTION OF THE DRAWINGS

For a more complete understanding of the disclosure, reference should be made to the following detailed description and accompanying drawings wherein:

FIG. 1A comprises a side cutaway diagram of a receiver according to various embodiments of the present invention;

FIG. 1B comprises a side detail cutaway diagram of a portion of a receiver according to various embodiments of the present invention;

FIG. 1C comprises an electrical diagram of the receivers of FIG. 1A according to various embodiments of the present invention;

FIG. 2A comprises a cross-sectional drawing of a receiver according to various embodiments of the present invention;

FIG. 2B comprises a perspective drawing of a serpentine path used in the receiver of FIG. 2A according to various embodiments of the present invention;

FIG. 3 comprises a cross-sectional diagram of a receiver according to various embodiments of the present invention;

FIG. 4A comprises a cross-sectional drawing of a receiver according to various embodiments of the present invention;

FIG. 4B comprises a perspective drawing of a screen used in the receiver of FIG. 2A according to various embodiments of the present invention;

FIG. 5 comprises a cross-sectional view of another example of a receiver according to various embodiments of the present invention;

FIG. 6 comprises a cross-sectional view of an example of a three way receiver according to various embodiments of the present invention;

FIG. 7 comprises a cross-sectional view of another example of a receiver according to various embodiments of the present invention;

FIG. 8A comprises a graph showing some of the beneficial results of utilizing an LF driver with a typical tube design used to vent the LF driver to the earphone described herein according to various embodiments of the present invention;

FIG. 8B comprises a graph showing the combined summed response of a two way design described herein according to various embodiments of the present invention;

FIG. 8C comprises a graph showing some of the beneficial results of the addition of a 3-way design described herein according to various embodiments of the present invention; and

FIG. 8D comprises a graph showing some of the beneficial results of system tuning using dampers according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Receivers are provided that in some aspects include an acoustic resistance (e.g., a screen, a single small hole, or a narrow slot to mention a few examples) disposed between a high frequency (HF) driver and the low frequency (LF) driver of the receiver (and in some cases an ultra high frequency (UHF) driver). In one aspect, a common front volume is formed by connecting the respective front volumes of the HF driver and the LF driver. An acoustic resistance (e.g., screen) is placed in the opening or passageway that connects the two front volumes. The screens, tubes, and/or serpentine path not only act to filter the output of the LF driver, but also make sure that sound from the HF driver does not communicate with the front chamber of the LF driver. The additional volume of the tubes, and/or serpentine path alters the response of the HF driver. A capacitor is connected in series with the high frequency driver. The combination of the inner screen (acting as a low pass filter) and the capacitor (acting as a high pass filter) provides overall control of the response shape. In this regard, these approaches reduce the impact of the LF driver resonance and the unwanted bass response from the HF driver. Greater design independence and improved sound quality are provided.

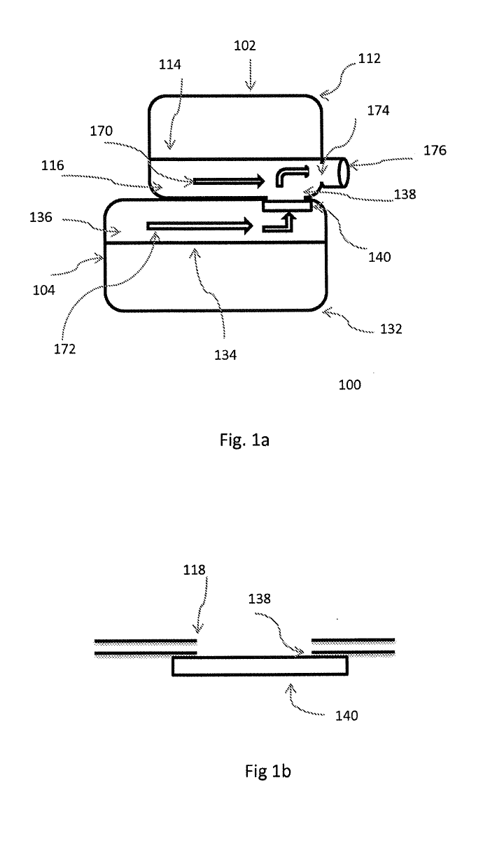

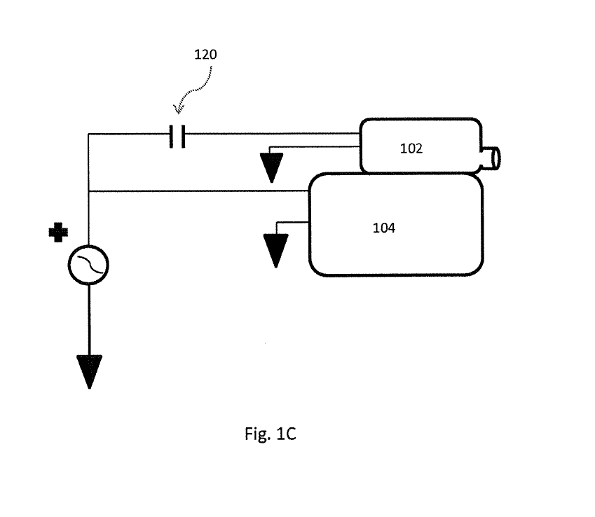

Referring now to FIG. 1A, FIG. 1B, and FIG. 1C, a receiver assembly includes a high frequency driver 102 and a low frequency driver 104. For simplicity, only some of the components of the drivers 102 and 104 are shown (e.g., the diaphragms and front volumes of the drivers). However, it will be appreciated that other elements common to drivers (e.g., mechanical linkages) also exist but as mentioned are not shown in FIG. 1 for simplicity.

The high frequency driver 102 includes a housing 112, a diaphragm 114, and a front volume 116. As used herein, “front volume” means refers to the cavity in the housing that is separated from the motor by the diaphragm 114. The diaphragm 114 creates a compliant and airtight division between the front and back volumes of a single receiver. A port 118 in the HF driver housing provides an opening into the front volume of the HF driver housing-thus both receivers share the same front volume thru the internal screen 140 in the LF Driver housing. A tube 176 connected to the common front volume in the HF driver allows sound output from the device.

A capacitor 120 is connected in series with the electrical input of the high frequency driver. This connection could be done through a terminal circuit board connected to the terminals of the coil. In one example, the capacitor 120 has a value of 2.2 uF (using R=1/(2*pi*f*c) where R is typically 40 ohms and f is typically 2 kHz). Other examples of values for the capacitor 120 are possible. It will also be appreciated that other elements besides a capacitor may also be used. For example, an active filter and a second amplifier, a resistor, a highly resistive coil, or a resistive inductive filter may be used to filter the signal to the driver 102. Other examples are possible.

The low frequency driver includes a housing 132, a diaphragm 134, and a front volume 136. A port 138 provides an opening in the housing 132. A screen 140 is disposed at the output of the low frequency driver 104. In one example, the screen 140 is coupled to the inside of the port 138 of the low frequency driver 104. In other examples it is coupled to the inside of the port 118 of high frequency driver 102. In still other examples, the screen 140 is coupled to both the high frequency driver 102 and the low frequency driver 104 through their connected ports 138 and 118. Coupling may be made by any convenient attachment or fastening mechanism such as glue. Other examples of coupling approaches are possible.

The ports 118 and 138 are openings in the respective housings. In one example, these opening are substantially circular shapes and have diameters of approximately 0.030 inches. Other examples of shapes and dimensions are possible.

With the high frequency driver 102, an output port 176 routes sound energy from the device. The ports 118 and 138 are coupled together and cause the high frequency driver 102 and the low frequency driver 104 to have a common front volume.

The screen 140 may be a mesh (e.g., constructed of a metal or a fabric) or a very thin metal film to mention a few examples. In this respect, the screen 140 may have very small openings (as in a mesh) or be solid (as in a film). In other aspects, a passive radiator (compliant mass) can be used in place of the screen. If a solid film without openings is used, the sizes of the ports 118 and 138 are substantially increased (e.g., substantially above 0.030 inches) and preferably compliance rolls are added. The performance can be still further improved by adding a rigid mass to the middle of the film.

The capacitor 120 is connected electrically to the input of the high frequency driver 102 acting like a high pass filter on the input.

In one example of the operation of the system of FIG. 1A, FIG. 1B, and FIG. 1C, a first electric signal may excite the first diaphragm 114 and/or a second electric signal may excite the second diaphragm 134. The process and elements used by drivers to excite the diaphragm 114 or 134 are well known to those skilled in the art and will not be discussed further here. Movement of the first diaphragm causes the creation of first sound energy 170 and movement of the second diaphragm causes creation of second sound energy 172. The sound energy 170 and 172 add to create a resultant sound energy 174 that exists through a sound tube 176, which is coupled to the output of the high frequency driver 102.

The internal screen 140 disposed between the low frequency driver 104 and the high frequency driver 102 and within the common front volume of these two drivers creates a low pass filtering effect for the low frequency driver 104. In this respect, frequencies above a particular cutoff frequency are attenuated. Selection of the cutoff frequency is made by the size of the port and the acoustic resistance of the internal screen. The capacitor 120 connected to the input of the high frequency driver provides for low pass filtering.

The combination of the screen 140 and the capacitor 120 allows for better control of the response shape. In one advantage of the present approaches, the combination of the screen 140 and the capacitor 120 is effective to remove the LF driver resonance (via the screen 140) and high frequency driver bass response (via the capacitor 120).

Referring now especially to FIG. 1B, one example of the screen 140 is shown. In this example, the screen 140 is a wire mesh screen of approximately 0.030 inches in diameter, and approximately 0.002 inches in thickness and constructed of a metal such as stainless steel. In other example, the screen 140 is constructed of a fabric or a very thin membrane. Other examples of materials and dimensions are possible.

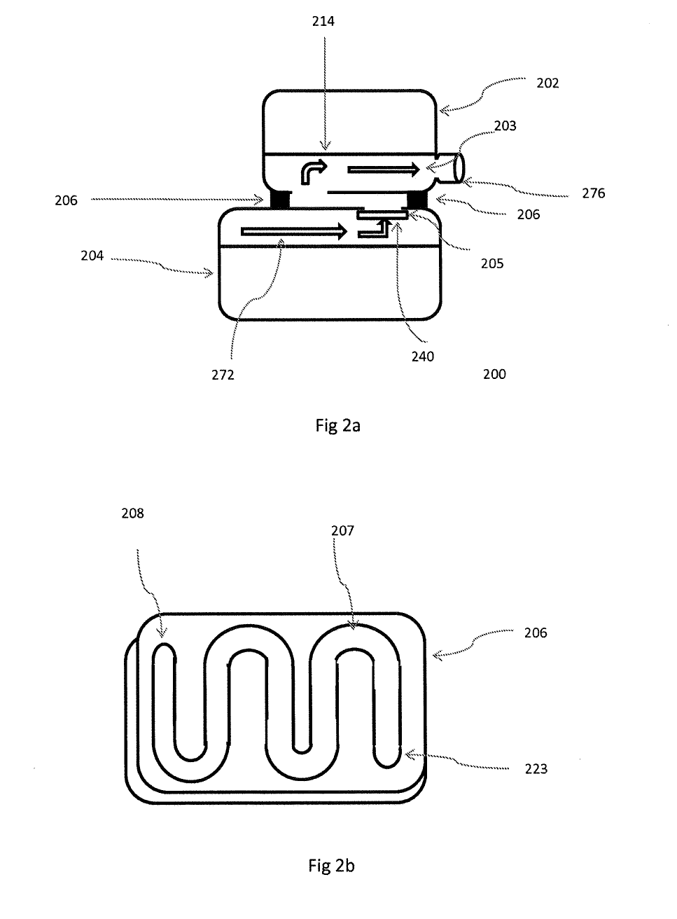

Referring now to FIGS. 2A and 2B, another example of an assembly 200 is described. The assembly 200 includes a high frequency (HF) driver 202 and a low frequency (LF) driver 204. The other components in these receivers are the same as those described above with respect to like-numbered components in FIG. 1A, FIG. 1B, and FIG. 1C, and this description will not be repeated here. An intermediate plate 206 has an intermediate path channel, or serpentine path 207 formed there through. The plate 206 is disposed between the HF driver 202 and the LF driver 204.

Sound 272 from the low frequency (LF) driver 202 passes from the low frequency driver 202, an internal screen 240, and through an opening 205 in the intermediate plate 206. The arrangement of the LF driver 204, the intermediate plate 206, and the HF driver 202 creates and forms the serpentine path 207 for the sound energy to travel from the low frequency driver 204 to the high frequency driver 202. The sound energy 272 travels the serpentine path 207 beginning at a first opening 223 through the path 207, then exits the serpentine path 207 at a second opening 208 (that is arranged to coincide with an opening in the high frequency driver 202). This sound energy 272 combines with the sound energy 203 produced by the high frequency driver 202 and exits the high frequency driver 202 through a sound tube 276. The serpentine path 207 in the plate 206 and the internal screen 240 are used to and filter and add additional inertance to the LF driver output; this allows for a tuning of the overall system response.

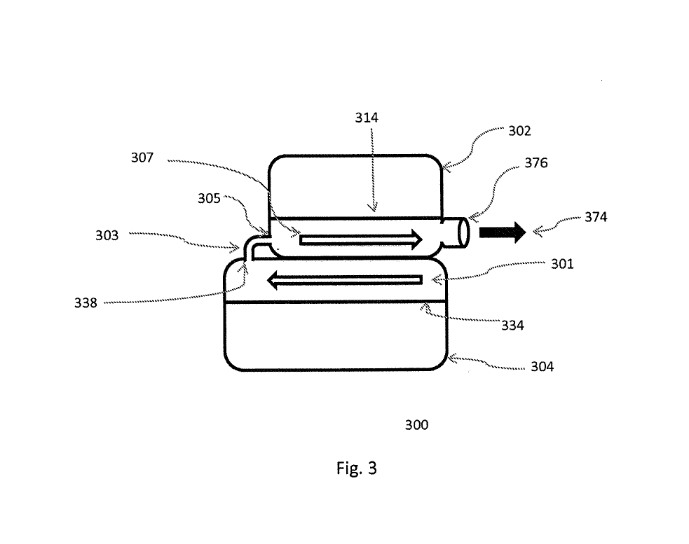

Referring now to FIG. 3, another example of an assembly 300 is described. The assembly 300 includes a high frequency (HF) driver 302 and a low frequency (LF) driver 304. The other components in these receivers are the same as those described above with respect to like-numbered components in FIG. 1A, FIG. 1B, and FIG. 1C, and this description will not be repeated here.

Sound energy 301 from the low frequency driver 304 passes through an opening in the cover of the low frequency driver 304. This opening can have an internal screen (not shown) and is integrated into an external tubing 303. The sound energy 301 then passes through the external tubing 303, through an opening 305 in the tubing 303, and into the high frequency driver 302. The sound energy 301 from the low frequency driver 304 combines with the energy 307 from the high frequency driver 302 and exits the sound tube 376 as sound energy 374. The external tubing 303 is used to filter and add additional inertance to the low frequency (LF) driver output, allowing for a tuning of the overall system response. As mentioned, an internal screen can also be inserted at the input or output of the tube 303.

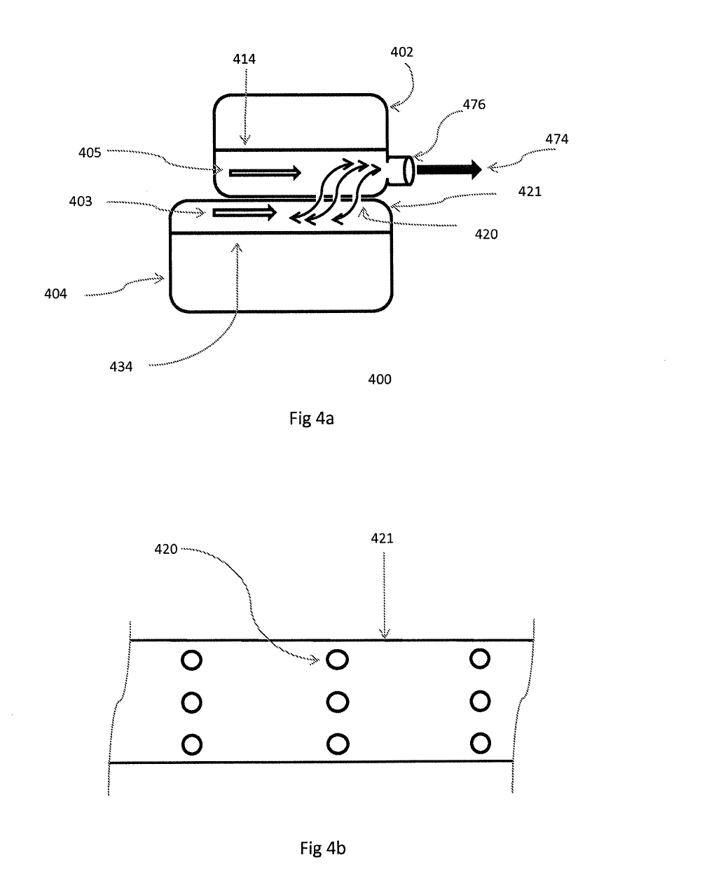

Referring now to FIG. 4A and FIG. 4B, another example of an assembly 400 is described. The assembly 400 includes a high frequency (HF) driver 402 and a low frequency (LF) driver 404. The other components in these receivers are the same as those described above with respect to like-numbered components in FIG. 1A, FIG. 1B, and FIG. 1C, and will not be repeated here.

Multiple small openings 420 through a housing 421 of the LF driver 404 allow for the passage of sound energy 403 from the low frequency driver 404. The openings 420 act as a low pass filter to the sound energy 403. The sound energy 403 combines with the sound energy 405 produced by the HF driver 402 to form sound energy 474 at the output of the sound tube 476. The diameter and quantity of the holes can be used to tune the LF response. For example, smaller openings can be used when more low pass filtering is desired and larger openings can be used when less low pass filtering is desired.

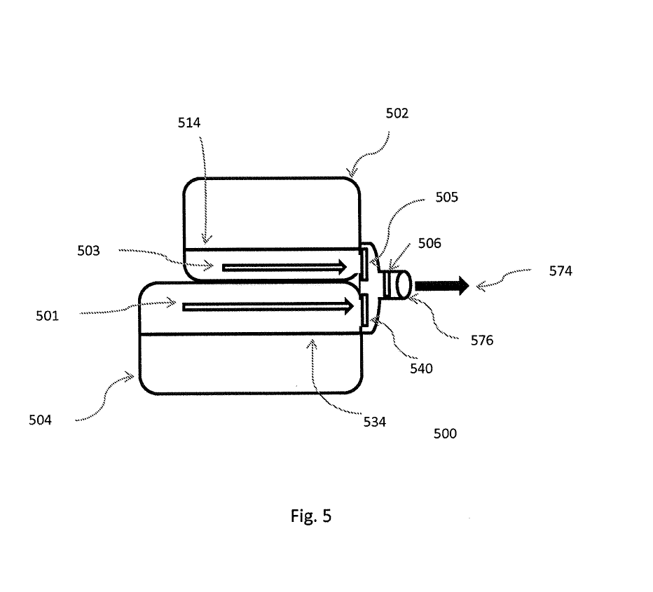

Referring now to FIG. 5, another example of an assembly 500 is described. The assembly 500 includes a high frequency (HF) driver 502 and a low frequency (LF) driver 504. The other components in these receivers are the same as those described above with respect to like-numbered components in FIG. 1A, FIG. 1B, and FIG. 1C, and will not be repeated here.

As shown in the assembly of FIG. 5, sound energy 501 from the low frequency driver 504 passes through a first internal screen 540. A second internal screen 505 is placed at the output of the high frequency driver 502. A third internal screen 506 is placed at the output of the tube 576. The sound energy 501 combines in the sound tube 576 with the sound energy 503 (produced by the high frequency driver 502) to form output sound energy 574. The combination of three internal screens (or dampers) 505, 540, and 506 is used to tune the overall system response.

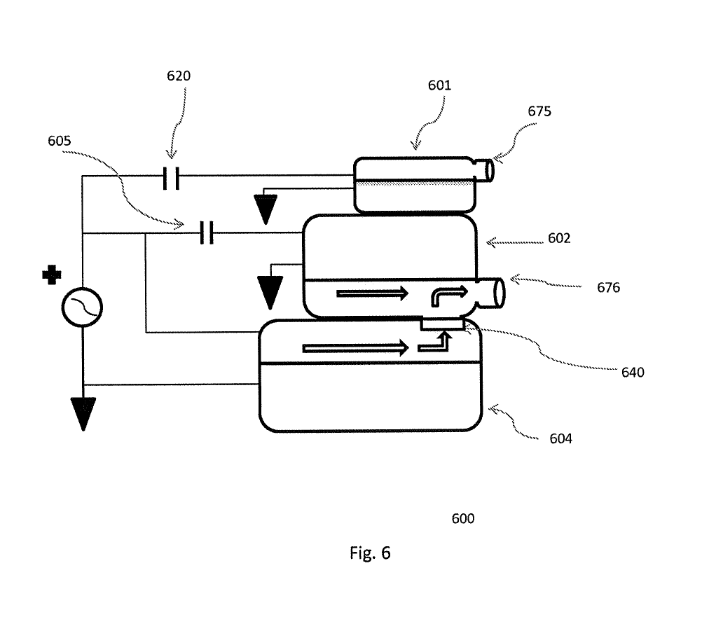

Referring now to FIG. 6, one example of a three-way system with two sound output tubes 675 and 676 is described. A first capacitor 620 is coupled to an ultra high frequency (UHF) driver 601 and produces a positive voltage. By “three-way” it is meant that three drivers are used, while “two-way” refers to two drivers being used. A second capacitor 605 is coupled to a high frequency (HF) driver 602. A low frequency (LF) driver 604 is coupled to the HF driver 602. An internal screen 640 is disposed in an opening that extends between the HF driver 602 and the LF driver 604. The screen 640 operates as described above with respect to the arrangement described in FIGS. 1A-1C. This arrangement creates a three-way system with the advantage of having two sound tubes. Having two sound tubes is advantageous because it reduces the amount of plumbing required to connect all drivers in the system.

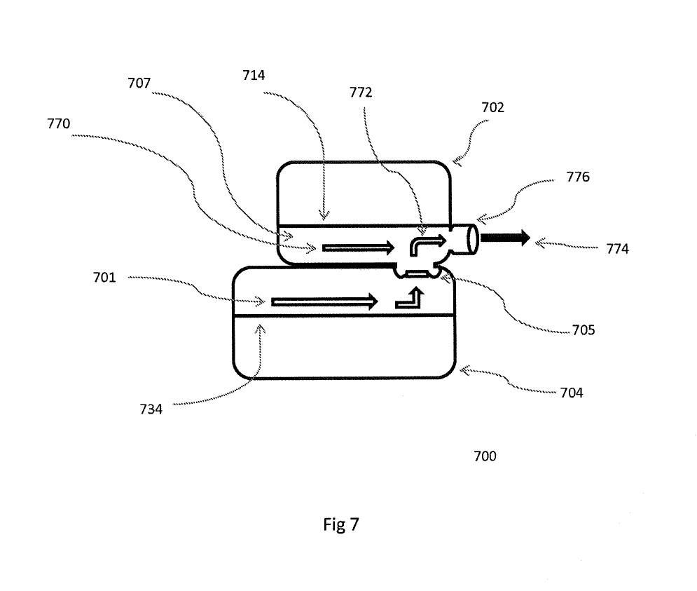

Referring now to FIG. 7, another example of an assembly 700 is described. The assembly 700 includes a high frequency (HF) driver 702 and a low frequency (LF) driver 704. The other components in these receivers are the same as those described above with respect to like-numbered components in FIG. 1A, FIG. 1B, and FIG. 1C, and the description will not be repeated here.

Sound energy 701 from the low frequency (LF) driver 704 impinges upon a compliant membrane 705. This sound energy 701 moves the membrane 705 in reaction to the sound pressure. The compliant membrane 705 can be constructed of Mylar, for example. The movement of the compliant membrane 705 creates sound energy 772 in the front volume 707 of the high frequency driver 702. This sound energy 772 combines with the sound energy 770 produced by the high frequency driver 702 and exits the HF driver 702 through the tube 776 as sound energy 774. The mass and compliance of the compliant membrane 705 is used to filter the sound energy entering into the high frequency driver 702, allowing for a tuning of the overall system response.

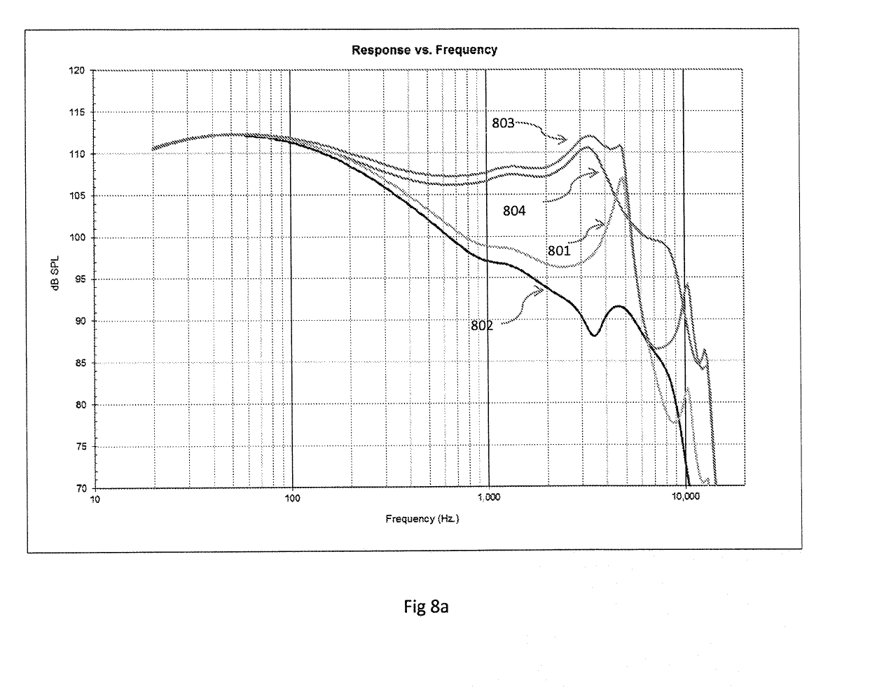

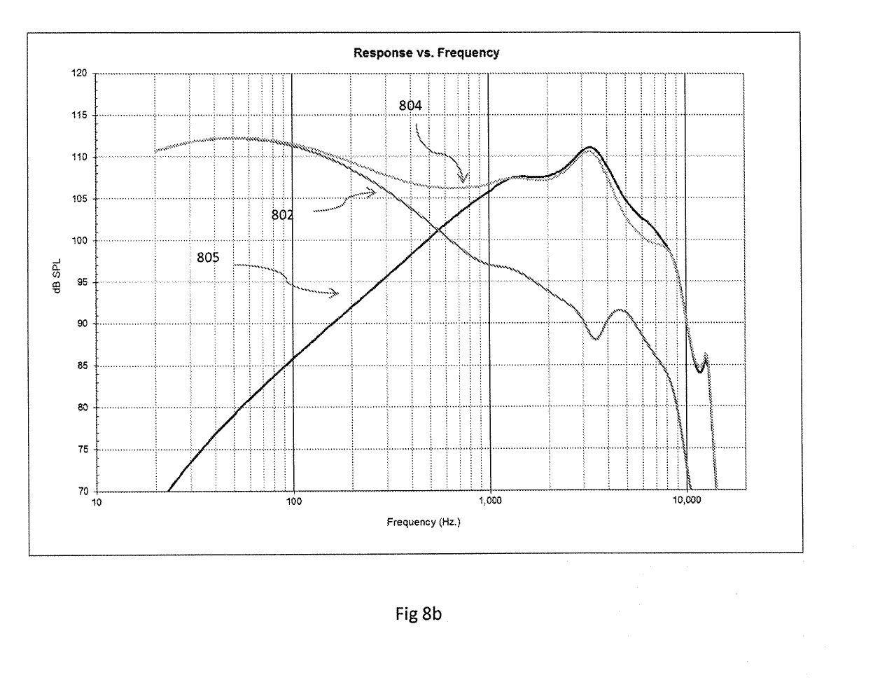

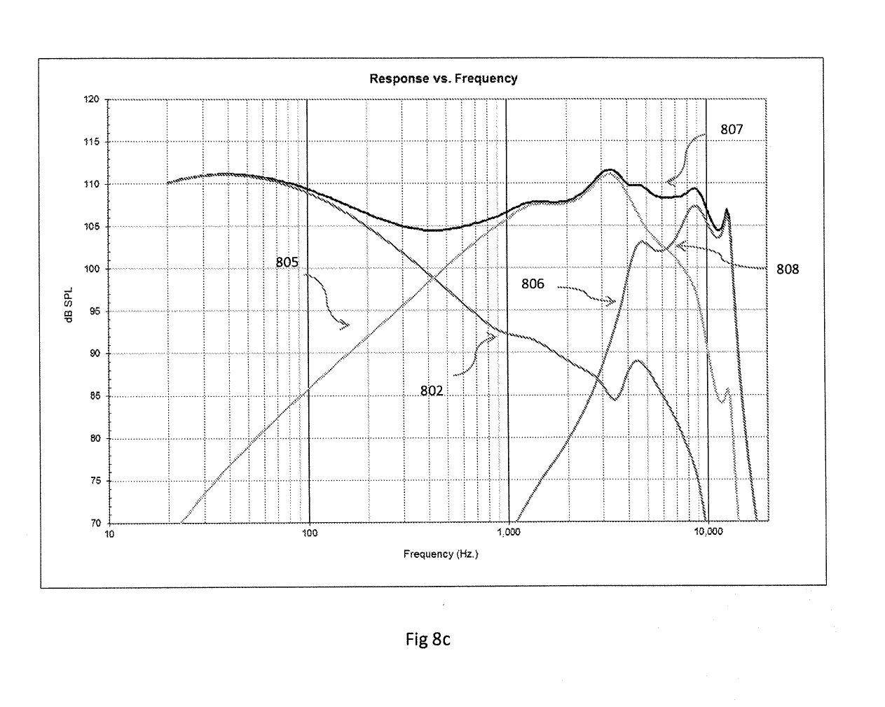

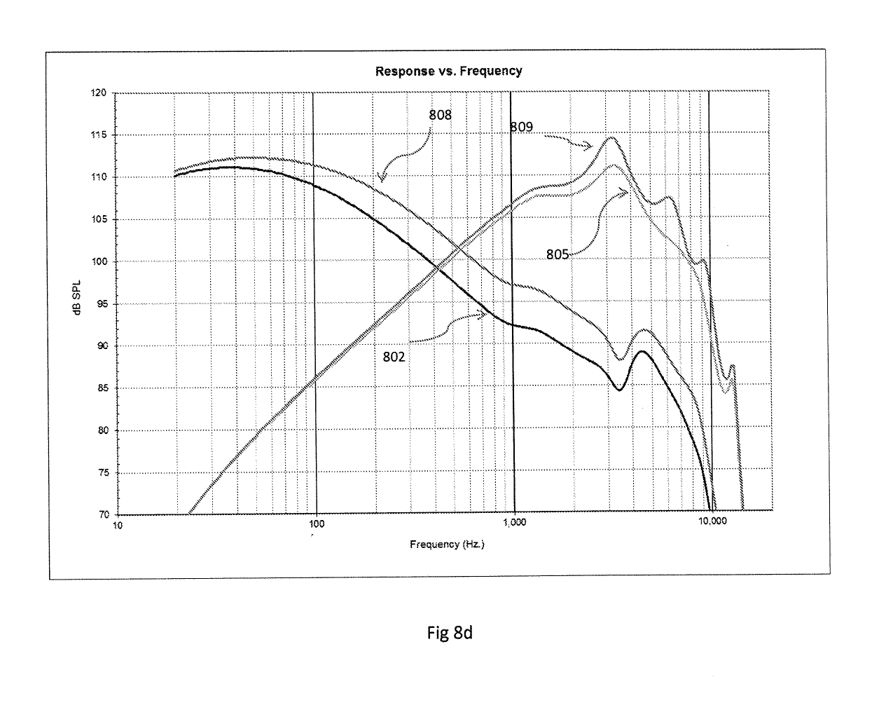

Referring now to FIG. 8A, FIG. 8B, FIG. 8C, and FIG. 8D, responses of the acoustic assemblies described herein are shown. FIG. 8A shows the response curve 801 of previous LF drivers with a tube design that is used to vent the LF driver to the earphone and the resonance peak of the tube at approximately 4.8 kHz that is not desired in the overall response. The summation curve 803 (of previous HF drivers) shows the inherent problem caused by this peak, namely, that the peak is too high in frequency to match the natural ear resonance at approximately 3 kHz. Response curve 802 shows how the approaches described herein removes the peak in the LF driver curve 801 and shows the new summed response 804.

Referring now to FIG. 8B, the combined summed response of a two-way design according to the present approaches is shown. Response curve 802 shows the response with the peak removed and the new summed response 804 according to the approaches described herein. Response curve 805 shows the high frequency response.

FIG. 8C shows the response of a three-way design and includes response curves 802, 805, 806, and 807. Response curve 802 is woofer response. Response curve 805 is the high frequency response. Response 806 curve is the ultra high frequency response. Response curve 807 shows the summed response of all 3 drivers. It can be seen that the resonance in the LF driver that would be problematic in a cross-over region 808 of the three-way summed response is removed.

FIG. 8D shows the benefits of system tuning using dampers (e.g., screens or dampers 505, 506, and 540 from the apparatus of FIG. 5). It will be appreciated that all devices described herein can potentially be tuned as shown in FIG. 8D.

The response curves 802, 808, 805 and 809 show the benefits of system tuning with dampers 505, 506, and 540 from FIG. 5. These three dampers can be chosen to have small, medium and large acoustic damping values. The damper 540 adjusts the roll off on the LF driver as shown by the response curve 802. The damper 505 adjusts the 3 kHz peak output level of the response curve 809 and secondary peaks. Finally, the damper 506 dampens both of the previously mentions curves equally as shown by the curve 808.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An acoustic apparatus, comprising:
a high frequency driver having a first front volume;
a low frequency driver having a second front volume;
wherein the first front volume and the second front volume communicate with each other to form a common front volume;
at least one acoustic resistance that is placed between the first front volume and the second front volume;
such that the at least one acoustic resistance acts as a low pass filter.

2. The acoustic apparatus of claim 1, wherein the at least one acoustic resistance comprises a screen, one or more holes, or a slot.

3. The acoustic apparatus of claim 1 further comprising an electrical network that is connected in series with the high frequency driver, wherein the electrical network acts as a filter to reduce low frequencies.

4. The acoustic apparatus of claim 3, wherein the electrical network comprises a capacitor.

5. The acoustic apparatus of claim 1, wherein the first front volume and the second front volume communicate via an opening.

6. The acoustic apparatus of claim 1, wherein the first front volume and second front volume communicate via a passageway.

7. The acoustic apparatus of claim 1, wherein the passageway is serpentine-shaped.

8. The acoustic apparatus of claim 1, wherein the passageway is a tube.

9. The acoustic apparatus of claim 1, wherein passageway includes multiple small openings.

10. The acoustic apparatus of claim 1, wherein the sound tube is formed with and communicates with the common front volume.

11. The acoustic apparatus of claim 1, wherein the high frequency driver has a first screen and low frequency driver has a second screen and both the high frequency driver and low frequency driver open into the passageway.

12. The acoustic apparatus of claim 1, further comprising an ultra-high frequency driver.
